(19) United States
(12) Patent Application Publication
(10) Pub. No.: US 2022/0163998 A1
(43) Pub. Date: May 26, 2022

(54) BODY PANELS WITH CONNECTORS

(71) Applicant: Hewlett-Packard Development Company, L.P., Spring, TX (US)

(72) Inventors: Cheng Kai Chen, Taipei City (TW); Chia Wei Ting, Taipei City (TW); Yi Chen Chen, Taipei City (TW); Kun Cheng Tsai, Taipei City (TW); Ying Hung Ku, Taipei City (TW); Hsueh Chen Hung, Taipei City (TW)

(73) Assignee: Hewlett-Packard Development Company, L.P., Spring, TX (US)

(21) Appl. No.: 17/296,959

(22) PCT Filed: Aug. 12, 2019
(86) PCT No.: PCT/US2019/046214

§ 371 Date: May 25, 2021

(51) Int. Cl. G06F 1/16

(52) U.S. Cl. CPC G06F 1/1635

(57) ABSTRACT

Examples of body panels with connectors are described herein. In an example, a body panel of a portable electronic device may include a connector affixed thereto, in an assembled state of the body panel on the portable electronic device, the connector may be positioned between a battery and a motherboard of the portable electronic device. The connector may electrically couple the battery with the motherboard, in the assembled state.

### BACKGROUND

Portable electronic devices, such as laptops, mobile phones, notebook computers, and tablets include components, such as a power source and an electrical component. The power source and the electrical component are electrically coupled to each other to enable operation of the portable electronic devices. The portable electronic devices also include a body panel to cover the power source and the electrical component.

### BRIEF DESCRIPTION OF FIGURES

The detailed description is provided with reference to the accompanying figures, wherein:

FIG. 1 illustrates a schematic of a body panel of a portable electronic device, according to an example;

FIG. 2 illustrates a perspective view of a body panel of a portable electronic device, according to an example;

FIG. 3 depicts a sectional view of a body panel in an assembled state on a portable electronic device, according to an example;

FIG. 4 illustrates a sectional view of a portable electronic device, according to an example; and

FIG. 5 illustrates a perspective view of a portable electronic device, according to an example.

### DETAILED DESCRIPTION

Portable electronic devices, such as mobile phones, tablets, laptops, etc. include various components, such as a power source and an electrical component, that are coupled together for operating the portable electronic devices, the power source may be a battery and the electrical component may be a printed circuit board or a motherboard of the portable electronic devices. In an example, the battery and the motherboard may be coupled by a cable and a connector. In another example, the battery and the motherboard may be coupled by a connector. The connector may be fixedly arranged between the battery and the motherboard to electrically couple them to each other.

Further, the components of the portable electronic devices are covered by a body panel, to protect the components from external factors, such as dust. During disassembly of the portable electronic device, the body panel may be removed to repair or replace any component of the portable electronic device. As the battery and the motherboard is electrically coupled, during disassembly, probability of occurrence of electrical short-circuits may become high. The electrical short-circuits may affect other electrical components of the portable electronic device, thereby causing irreparable damage to the portable electronic device.

The present subject matter discloses example body panels with connectors for portable electronic devices. The body panels of the present subject matter facilitate prevention of electrical short-circuit between different components, such as a power source and an electrical component, two electrical components, one electrical component and a plurality of wires, one electrical component and one flexible circuit board, or other components, of a portable electronic device, while disassembling the portable electronic device.

As per the present subject matter, the body panel of the portable electronic device may include a connector that may be affixed to the body panel. The connector may be an interposer that may provide an electrical interface that routes between one connection to another. In an assembled state of the body panel on the portable electronic device, the connector may get positioned in a gap between the battery and the motherboard of the portable electronic device. As a result, the connector may electrically couple the battery with the motherboard in the assembled state of the body panel on the portable electronic device. In a disassembled state of the body panel, the connector may be removed from the gap and the electrical coupling between the battery and the motherboard may be disconnected upon disassembling.

Accordingly, the removable placement of the connector fixedly attached to the body panel of the present subject matter facilitates in disconnecting the electrical connection between the battery and the motherboard during disassembly of the body panel. The connector may thereby prevent any chances of short-circuit between components, such as the power source and the electrical component of the portable electronic device.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

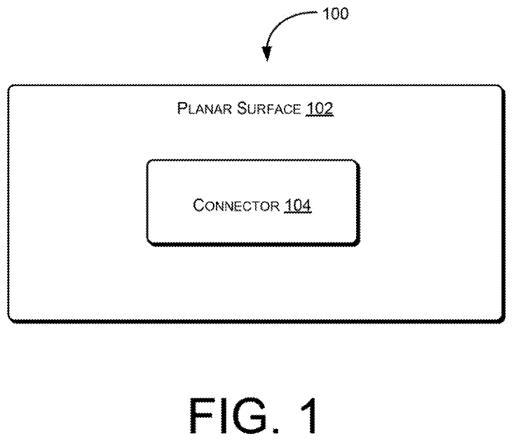

The manner in which the body panels and the portable electronic devices implementing the body panels are implemented are explained in detail with respect to FIGS. 1-5. While aspects of described body panels and portable electronic devices can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates a schematic of a body panel 100 of a portable electronic device (not shown in FIG. 1), in accordance with an example. Examples of the portable electronic device may include, but are not limited to, a laptop computer, a notebook computer, a tablet, and a mobile phone. The body panel 100 may be an outer casing of the portable electronic device or a portion thereof. For example, the body panel 100 may be employed for covering various electrical components, such as a battery and a motherboard, of the portable electronic device. The body panel 100 may be formed from materials including an aluminium material, a plastic material, or carbon composites, and so on, including combinations thereof.

The body panel 100 may include a planar surface 102 that may face the battery and the motherboard in an assembled state of the body panel 100 on the portable electronic device. For example, the planar surface 102 may be an inner surface of the body panel 100, in the assembled state of the body panel 100 on the portable electronic device. The assembled state of the body panel 100 may be the state when the body panel 100 is disposed on or attached to the portable electronic device. In an example, the body panel 100 may be attached to the portable electronic device by way of screw fasteners, snap fit mechanism, and the like.

Further, the body panel 100 includes a connector 104 affixed on the planar surface 102 of the body panel 100. The connector 104 is to form interconnections between two electrical components, such as the battery and the motherboard. In an example, the connector 104 may be affixed on the planar surface 102 using screw fasteners, adhesives, etc. in the assembled state of the body panel 100 on the portable electronic device, the connector 104 may get positioned between the battery and the motherboard of the portable electronic device. The connector 104 may thus, electrically couple the battery with the motherboard.

The body panel 100 thus ensures that during disassembly of the body panel 100, the connector 104 is removed from between the battery and the motherboard, thereby disconnecting the electrical coupling between the battery and the motherboard. As a result, short-circuit may be avoided from occurring.

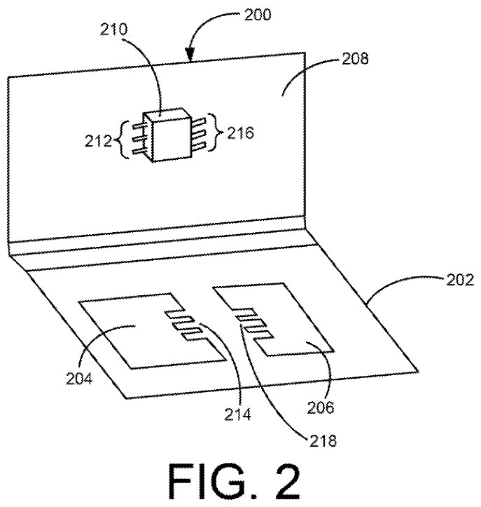

FIG. 2 illustrates a perspective view of a body panel 200, according town example. The body panel 200 may be assembled on a portable electronic device 202. Examples of the portable electronic device 202 may include, but are not limited to, a laptop, a notebook computer, a tablet, a smart phone, and so on. The portable electronic device 202 may include a battery 204 and a motherboard 206 for being electrically coupled to each other. In an example, when the portable electronic device 202 is a laptop, the body panel 200 may be considered as a D-cover of the laptop. In another example, when the portable electronic device 202 is a tablet, the body panel 200 may be considered as a back cover of the tablet. The body panel 200 may be therefore that portion or cover of the portable electronic device 202, which covers the battery 204 and the motherboard 206 of the portable electronic device 202.

The body panel 200 may include a planar surface 208 that may face the battery 204 and the motherboard 206, when the body panel 200 is attached to the portable electronic device 202. In an example, the body panel 200 may also include a connector 210 affixed on the planar surface 208. For example, the connector 210 may be attached to the body panel 200 by screw fasteners, adhesives, and so on. In an example implementation, the body panel 200 and the connector 210 may include openings (not shown) to receive fasteners. The fasteners may be inserted in the openings to affix the connector 210 with the body panel 200. In an example, the connector 210 may be made of a plastic material. The connector 210 may act as a bridge to electrically couple the battery 204 and the motherboard 206 of the portable electronic device 202.

Though the connector 210 is depicted to have a rectangular shape, the connector 210 may have any suitable shape based on the portable electronic device in which the connector 210 may be implemented. In an example implementation, the connector 210 may have a shape to provide a space efficient interconnection between the battery 204 and the motherboard 206.

In an example implementation, the connector 210 includes a first set of interconnects 212 to connect with corresponding interconnects 214 of the battery 204. Further, the connector 210 includes a second set of interconnects 216 to connect with corresponding interconnects 218 of the motherboard 206. For example, the first set of interconnects 212 may be female connectors to receive corresponding male connectors 214 of the battery 204. In other example, the second set of interconnects 216 may be male connectors configured to receive corresponding female connectors 218 of the motherboard 206. The number of the first set of interconnects 212 and the second set of interconnects 216 may vary based on the portable electronic device 202 in which the connector 210 may be implemented.

In an example, the first set of interconnects 212 and the second set of interconnects 216 may be made of a conductive material. In another example, the first set of interconnects 212 and the second set of interconnects 216 may be coated with a layer of the conductive material. Examples of the conductive material may include, but are not limited to, Gold, Silver, Copper, Beryllium, Titanium, Brass, or a combination thereof. Although the first and second sets of interconnects 212 and 216 are depicted as extending outwards from the connector 210, the first and second set of interconnects 212 and 216 may be surface interconnects, such as metal plated contact areas.

To assemble the body panel 200 on the portable electronic device 202, the body panel 200 may be attached to a chassis (not shown in FIG. 2) of the portable electronic device 202. For example, the body panel 200 may include guiding surfaces (not shown) along lateral edges thereof that may cooperate with corresponding guiding surfaces of the chassis to allow the body panel 200 to cover the battery 204 and the motherboard 206 of the portable electronic device 202. In the assembled state, the connector 210 may be positioned in the gap between the battery 204 and the motherboard 20, to electrically couple the two.

During repairing or replacement of any component of the portable electronic device 202, the body panel 200 may be removed to disassemble the portable electronic device 202, The removal of the body panel 200 from the portable electronic device 202 leads to removal of the connector 210, thereby disconnecting the electrical coupling between the battery 204 and the motherboard 206 of the portable electronic device 202.

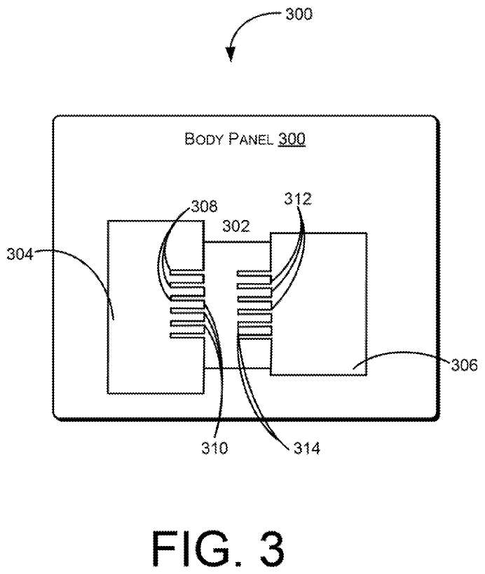

FIG. 3 depicts a sectional view of a body panel 300 in an assembled state on a portable electronic device (not shown), according to an example. The body panel 300 may be attached to a connector 302, for example, on a planar surface (not shown) of the body panel 300. The connector 302 may be an interposer that may provide an electrical interface between one component to another component of the portable electronic device. For example, the connector 302 may be fastened to the planar surface of the body panel 300 using fasteners, such as screws, bolts, and the like.

The assembled state of the body panel 300 may be a state when the body panel 300 is attached to the portable electronic device to cover a battery 304 and a motherboard 306 of the portable electronic device. For example, in the assembled state, the body panel 300 may render the battery 304 and the motherboard 306 inaccessible to a user. In an example implementation, the body panel 300 may include a plurality of protrusions (not shown) for being received by a plurality of notches (not shown) formed on a chassis (not shown) of the portable electronic device. In another example implementation, the body panel 300 may be attached to the portable electronic device by using screw fasteners.

As depicted in FIG. 3, in the assembled state of the body panel 300 on the portable electronic device, the connector 302 may fit within a space available between the battery 304 and the motherboard 306, to electrically couple the battery 304 with the motherboard 306. In an example, the connector 302 may include a first set of interconnects 308 to mate with corresponding interconnects 310 of the battery 304. In another example, the connector 302 may include a second set of interconnects 312 to mate with corresponding interconnects 314 of the motherboard 306.

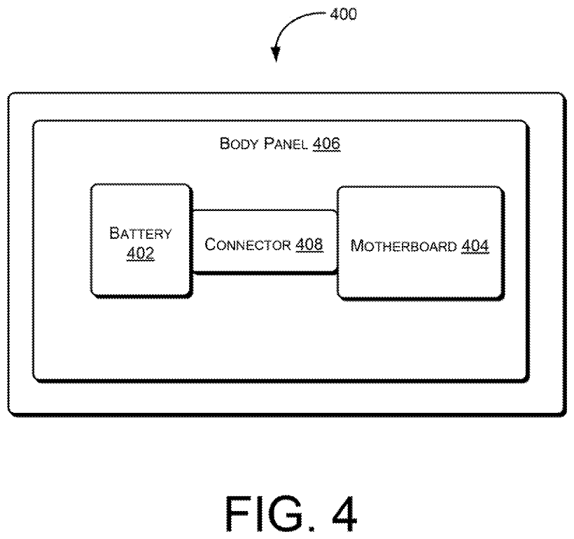

FIG. 4 illustrates a sectional view of a portable electronic device 400, according to an example. Examples of the portable electronic device may include, but are not limited to, a laptop computer, a notebook computer, a tablet, and a mobile phone. The portable electronic device 400 may include a battery 402, such as a lithium-ion battery. Further, the portable electronic device 400 may include a motherboard 404 for being coupled to the battery 402. The motherboard 404 may include additional components, such as a processor and a memory (not shown) of the portable electronic device 400.

The portable electronic device 400 may also include a body panel 406 to cover the battery 402 and the motherboard 404 in an assembled state of the body panel 406 on the portable electronic device 400. The body panel 406 may include an outer casing of the portable electronic device 400 or a portion thereof.

Further, the portable electronic device 400 may include an connector 408 that may be affixed to the body panel 406. The connector 408 may provide interconnections between two electronic components, such as the battery 402 and the motherboard 404. In an example, in an assembled state of the body panel 406 on the portable electronic device 400, the connector 408 may be removably positioned between the battery 402 and the motherboard 404 to electrically couple the battery 402 with the motherboard 404.

As the connector 408 may be affixed to the body panel 406, the connector 408 may connect the electrical coupling between the battery 402 and the motherboard 404 during assembly of the portable electronic device 400. Further, during disassembly, the connector 408 may get removed from in-between the battery 402 and the motherboard 404. The connector 408 may thus, facilitate in preventing any short-circuit during disassembly of the portable electronic device 400.

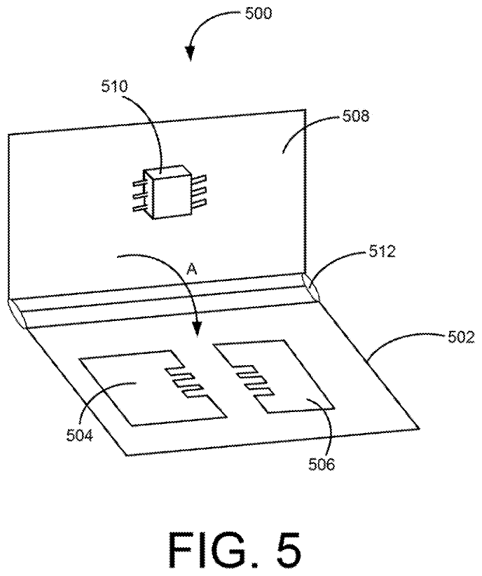

FIG. 5 illustrates a perspective view of a portable electronic device 500, according to an example. The portable electronic device 500 may be similar to portable electronic devices 202, 302, and 400. The portable electronic device 500 may include a chassis 502. In an example, the chassis 502 may be a metal frame that may serve as a structural support for various electronic components of the portable electronic device 500. For example, the portable electronic device 500 may include a power source 504, such as a battery, and an electrical component 506, such as a motherboard, disposed on the chassis 502.

The portable electronic device 500 may include a body panel 508 to cover the power source 504 and the electrical component 506 on the chassis 502, in a coupled state of the body panel 508 to the chassis 502. The body panel 508 may be an outer casing of the portable electronic device or a portion thereof. The body panel 508 may be formed from materials including an aluminium material, a plastic material, or carbon composites, and so on, including combinations thereof.

The portable electronic device 500 may also include a connector 510 affixed to the body panel 508. In an example, the connector 510 may be a connector that may provide interconnections between two electronic components, such as the power source 504 and the electrical component 506.

In addition, the portable electronic device 500 may include a coupling element 512 to couple the body panel 508 with the chassis 502. In an example, the coupling element 512 may include a hinge to couple the body panel 508 to the chassis 502. In an example, in the coupled state of the body panel 508 with the portable electronic device 500, the connector 510 may position between the power source 504 and the electrical component 506 to electrically couple the power source 504 with the electrical component 506.

In an example, in the coupled state of the body panel 508, the body panel 508 may overlap the chassis 502 to cover the power source 504 and the electrical component 506. For example, as depicted in FIG. 5, in the coupled state, the body panel 508 may move in the direction of arrow A such that the connector 510 may be positioned between the power source 504 and the electrical component 506 to electrically couple the power source 504 with the electrical component 506. For example, the connector 510 may fit in a gap or space between the power source 504 and the electrical component 506, in the coupled state of the body panel 508. The coupled state may be similar to the assembled state of the body panel, as described above with reference to FIGS. 1-4.

In an uncoupled state of the body panel 508, the body panel 508 may be removed, such as for repair, from the chassis 502 of the portable electronic device 500. As the body panel 508 is detached from the chassis 502, the connector 510 may get detached from the portable electronic device 500 along with the body panel 508. As a result, the electrical coupling between the power source 504 and the electrical component 506 may get disconnected.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A body panel to cover a battery and a motherboard of an electronic device, the body panel comprising:
a planar surface to face the battery and the motherboard in an assembled state of the body panel on the electronic device; and
a connector affixed on the planar surface, wherein in the assembled state of the body panel on the electronic device, the connector is to position between the battery and the motherboard and to electrically couple the battery with the motherboard.

2. The body panel as claimed in claim 1, wherein the connector comprises:
a first set of interconnects to connect with corresponding interconnects of the battery; and
a second set of interconnects to connect with corresponding is interconnects of the motherboard.

3. The body panel as claimed in claim 2, wherein the first set of interconnects and the second set of interconnects is formed of a conductive material.

4. The body panel as claimed in claim 1, wherein the body panel is one of a back cover and a D-cover of the electronic device.

5. The body panel as claimed in claim 1, wherein in a disassembled state of the body panel, the electrical coupling of the battery and the motherboard is disconnected.

6. A portable electronic device comprising:
a battery;
a motherboard;
a body panel to cover the battery and the motherboard in an assembled state of the body panel on the portable electronic device; and
a connector affixed to the body panel, for being removably positioned between the battery and motherboard,
wherein in the assembled state, the connector is to position between the battery and the motherboard to electrically couple the battery with the motherboard.

7. The portable electronic device as claimed in claim 6, wherein in a disassembled state of the portable electronic device, the electrical coupling of the battery and the motherboard is disconnected.

8. The portable electronic device as claimed in claim 6, wherein the body panel is one of a back cover and a D-cover of the portable electronic device.

9. The portable electronic device as claimed in claim 6, wherein the connector comprises:
a first set of interconnects to connect with corresponding interconnects of the battery; and
a second set of interconnects to connect with corresponding interconnects of the motherboard.

10. The portable electronic device as claimed in claim 9, wherein the first set of interconnects and the second set of interconnects is formed of a conductive material.

11. A portable electronic device comprising:
a chassis;
a power source disposed on the chassis;
an electrical component disposed on the chassis;
a body panel to cover the power source and the electrical component on the chassis, in a coupled state of the body panel with the portable electronic device;
a connector affixed to the body panel; and
a coupling element to couple the body panel with the chassis, wherein in the coupled state of the body panel with the portable electronic device, the connector is to position between the power source and the electrical component and to electrically couple the power source with the electrical component.

12. The portable electronic device as claimed in claim 11, wherein the connector is affixed to a planar surface of the body panel to face the power source and the electrical component in the coupled state.

13. The portable electronic device as claimed in claim 11, wherein in an uncoupled state of the body panel with the portable electronic device, the electrical coupling of the power source and the electrical component is disconnected.

14. The portable electronic device as claimed in claim 11, wherein the connector comprises:
a first set of interconnects to connect with corresponding interconnects of the power source; and
a second set of interconnects to connect with corresponding interconnects of the electrical component.

15. The portable electronic device as claimed in claim 14, wherein the first set of interconnects and the second set of interconnects is formed of a conductive material.
